(19) United States
(12) Patent Application Publication
(10) Pub. No.: US 2007/0029283 A1
(43) Pub. Date: Feb. 8, 2007

(54) Etching processes and methods of forming semiconductor constructions

(75) Inventor: David J. Keller, Boise, ID (US)

Correspondence Address: WELLS ST. JOHN P.S., 601 W. FIRST AVENUE, SUITE 1300, SPOKANE, WA, 99201, US

(73) Assignee: Micron Technology, Inc.

(21) Appl. No.: 11/196,681

(22) Filed: Aug. 2, 2005

(51) Int. Cl. C23F 1/00; C03C 15/00; B44C 1/22

(52) U.S. Cl. 216/67; 438/706

(57) ABSTRACT

The invention includes a method of processing a substrate. A substrate is provided within a high-density plasma reactor. A low-density plasma is generated and the substrate is plasma etched under low-density plasma conditions. The invention includes a method of forming a gate stack. A substrate having a plurality of layers is provided. A layer of nitride material is formed over the plurality of layers. The substrate is positioned within a high-density plasma reactor and a composition is flowed into the reactor while maintaining a mass flow within the reactor of at least 200 sccm. A plasma is generated and utilized to etch the nitride material. The invention includes a method of forming a plurality of features over a semiconductive wafer. A layer of nitride material is provided over a wafer surface. The nitride material is etched within a high-density plasma reactor utilizing low-density plasma conditions.

### TECHNICAL FIELD

The invention pertains to methods of processing a substrate, methods of forming gate stacks, methods of defining isolation regions, and methods of forming a plurality of features over a semiconductive substrate.

### BACKGROUND OF THE INVENTION

Numerous etching processes have been developed for utilization during semiconductor fabrication. In particular applications, etching is utilized to selectively remove portions of one or more materials or layers from a substrate. In particular instances, etch processing can utilize a patterned mask where the etch selectively transfers the pattern from the mask into underlying materials. Such etch processes can be utilized to form a variety of features during processing of a semiconductive wafer.

Conventional etching techniques and methodology can often result in variation of a specific feature dimension or critical dimension (CD) from one area to another area of a wafer. For example, etch processing during gate stack formation can produce a gate stack critical dimension near the center of a wafer which varies relative to the resulting critical dimension of gate stacks proximate the wafer edge. The non-uniformity can be due at least in part to non-uniform etch rates from center to edge of the wafer. For example, during etching of a nitride material, the etch rate can be faster on the edge of the wafer relative to the etch rate in the center of the wafer. Similarly, the etch rate of resist materials can be greater on the edge of the wafer relative to the etch rate of the resist at or near the center of the wafer. The variance in etch rates can result in CDs of features such as, for example gate stacks, on the edge of the wafer being smaller than corresponding CDs in the center of the wafer. In attempt to compensate for the CD non-uniformity, conventional etching processes have utilized a variance in temperature or different temperature zones across a wafer. Such temperature variance techniques have produced limited CD uniformity improvements. However, the temperature variance can be expensive and does not entirely correct or compensate CD non-uniformity. Accordingly, it would be desirable to develop alternative etch processing, methodology and systems.

### SUMMARY OF THE INVENTION

In one aspect, the invention encompasses a method of processing a substrate. A substrate is provided within a high-density plasma reactor. A low-density plasma having a plasma density of less than 10¹⁰ ions/cm³ is generated within the plasma reactor. The substrate is plasma etched under low-density plasma conditions to remove at least some of a material from the substrate.

In one aspect, the invention encompasses a method of forming a gate stack. A substrate having a plurality of layers is provided. A layer of nitride material is formed over the plurality of layers. The substrate is positioned within a high-density plasma reactor and a composition is flowed into the reactor while maintaining a mass flow within the reactor of at least 200 sccm. The composition is utilized for generating a plasma and plasma etching the nitride material.

In one aspect, the invention encompasses a method of forming a plurality of features over a semiconductive wafer. A layer of nitride material is provided over a wafer surface and the wafer is provided within a high-density plasma reactor. The nitride material is etched within the high-density plasma reactor utilizing low-density plasma conditions.

### BRIEF DESCRIPTION OF THE DRAWINGS

Preferred embodiments of the invention are described below with reference to the following accompanying drawings.

FIG. 1 is a diagrammatic, cross-sectional view of a semiconductor wafer fragment illustrating a structure formed in accordance with the methodology of the invention.

FIG. 2 is a diagrammatic fragmentary cross-sectional view of a semiconductor wafer fragment at a preliminary step of a method of the present invention during formation of the structure depicted in FIG. 1.

FIG. 3 is a view of the FIG. 2 wafer fragment at a processing step subsequent to that of FIG. 2.

FIG. 4 is a view of the FIG. 2 wafer fragment illustrating a processing step subsequent to that of FIG. 3.

FIG. 5 is a view of the FIG. 2 wafer fragment illustrating a processing step subsequent to that of FIG. 4.

FIG. 6 is a diagrammatic fragmentary cross-sectional view of a semiconductor wafer fragment illustrating a preliminary step of a method in accordance with an alternative aspect of the present invention.

FIG. 7 is a view of the FIG. 6 wafer fragment at a processing step subsequent to that shown in FIG. 6.

FIG. 8 is a view of the FIG. 6 wafer fragment of a processing step subsequent to that of FIG. 7.

FIG. 9 is a view of the FIG. 6 wafer fragment shown at a processing step subsequent to that of FIG. 8.

FIG. 10 is a view of the FIG. 6 wafer fragment at a processing step subsequent to that shown in FIG. 9.

FIG. 11 is a diagrammatic, cross-sectional schematic view of a plasma reaction system which can be utilized in methods of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

In general, methodology of the present invention is developed to provide an improved uniformity of critical dimension of features produced utilizing etching techniques. Methodology of the invention can be utilized to adjust etch rates of one or more materials and can be specifically utilized to adjust etch rates relative to the location on a semiconductor wafer of the material(s) being etched.

Many conventional etching techniques produce features having a critical dimension variance across the surface of a wafer. This can typically be due, at least in part, to faster etching of a particular material or materials proximate an edge of the wafer relative to the corresponding material disposed at or near the center of the wafer. Attempts to compensate for faster etching which occurs near the edge of a wafer have typically focused on adjusting and/or varying processing temperatures. Methodology in accordance with the invention is able to more fully compensate for etch rate variance by adjusting and/or varying parameters such as flow rate(s). Methodology of the invention can produce a CD uniformity across the wafer such that the CD of a particular feature disposed at the center of a wafer is substantially identical to the CD of a corresponding feature at or near the edge of the wafer (center to edge uniformity), where substantially identical refers to a lack of detectable difference.

Methodology of the invention can also be utilized to compensate for variances across the wafer present prior to the etching process. For example, where a particular material layer or plurality of layers has a thickness and/or density variance across the wafer, etching methodology in accordance with the invention can be utilized to adjust or modify an etch rate across the wafer to produce features having a uniform critical dimension across the entire wafer.

Methodology in accordance with the invention can provide improved CD uniformity relative to conventional methodology and, in particular instances can provide a CD uniformity across an entire wafer such that no CD variance is detectable across the wafer. Processing in accordance with the invention typically utilizes plasma etching conducted in a high-density inductively coupled plasma reactor. For purposes of the present description, a “high-density plasma” refers to a plasma having a plasma density of greater than or equal to 10¹⁰ ions/cm³, and a low-density plasma refers to a plasma having a plasma density of less than 1010 ions/cm³. Processing in accordance with the invention typically utilizes a low-density plasma within the high-density plasma reactor.

Processing utilizing plasma etching in accordance with the invention can typically comprise flowing one or more etch chemistry components into a reactor chamber and generating a low-density plasma within the chamber. In contrast with conventional technologies, at least one component of the etch chemistry is provided at a flow rate which is increased relative to the corresponding flow rate conventionally utilized or recommended for high-density plasma etching. Additionally, methodology in accordance with the invention can comprise variance of flow rates of one or more etch composition components during the etching process.

In general, a total flow of process gases into/through the plasma reactor will be higher for performing methodology in accordance with the invention relative to conventional processing and can typically be higher than the total mass flow rate suggested by manufacturer of the high-density plasma system being employed. In addition to a relatively high mass flow rate, methodology of the invention can additionally involve a difference and/or variance in additional parameters relative to conventional processing. Additional parameters which can be altered include but are not limited to, top coil power, bias power, chamber pressure and temperature.

Etch processing in accordance with the invention is not limited to any particular material to be etched. Accordingly, the etch chemistry utilized in is also not limited to a particular chemistry and can vary based upon the material or materials to be etched and/or the desired etch selectivity. The methodology of the invention can be utilized to replace conventional processing at any wafer processing step involving etch chemistry, especially those that have conventionally utilized high-density plasma etching. Appropriate etch chemistry and components thereof can be those conventionally used or yet to be developed, for a particular materials or combination of materials to be etched. The ratio of components utilized for processing of the invention can be identical to, similar to, or can vary relative to prior art etch processing.

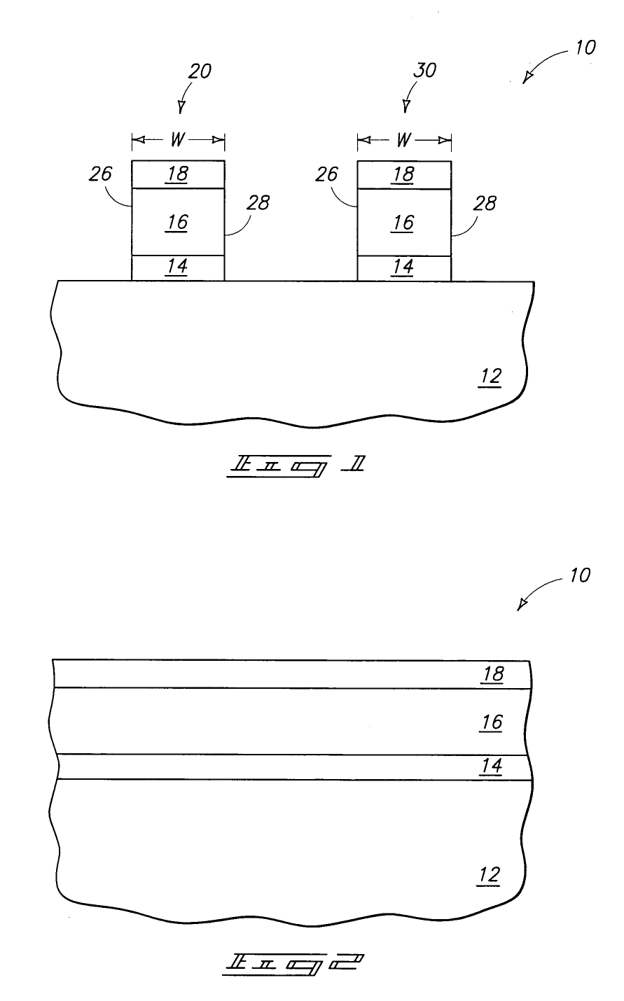

Methodology of the invention can be particularly useful during etch processing events that can affect an overall critical dimension of a feature. Exemplary processes for which the methodology of the invention can be particularly advantageous are discussed below with reference to FIGS. 1-10. Although the exemplary processing is discussed in terms of nitride material etch chemistries, it is to be understood that the concepts of the invention encompass adaptation for alternative and/or additional materials and/or etch selectivities.

Referring initially to FIG. 1, such depicts a wafer fragment 10 comprising a substrate 12 having a pair of gate stack structures 20 and 30 formed thereover. Gate structures 20 and 30 each comprise a gate oxide layer 14 (which typically comprises silicon dioxide), a conductive material 16 (which can comprise, for example, one or more of conductively-doped silicon, metal, and metal compounds) and an insulative cap 18. Insulative cap material 18 can comprise, for example, one or both of silicon dioxide and silicon nitride. Although the discussion of methodology in accordance with the invention is discussed below with respect to material 18 being silicon nitride, it is to be understood that the etched composition and parameters can be adapted for alternative insulative cap materials.

Semiconductive substrate 12 can comprise, for example, conductively-doped monocrystalline silicon. To aid in interpretation of the claims that follow, the terms “semiconductive substrate” and “semiconductor substrate” are defined to mean any construction comprising semiconductive material, including but not limited to, bulk semiconductive material such as a semiconductive wafer (either alone or in assemblies comprising of the materials thereon), and semiconductive material layers (either alone or in assemblies comprising other materials). The term “substrate” refers to any supporting structure, included but not limited to, the semiconductive substrates described above.

Each of gate stacks 20 and 30 have opposing sidewalls 26 and 28 such that each stack has an overall width w. The width w can be referred to as the critical dimension (CD) of the gate stack features. The width of the gate stack at this stage of processing, and the center to edge uniformity of such CD can affect the eventual CDs of the transistor gates into which the stacks will be incorporated in a final semiconductor structure. Etch processing in accordance with the invention can be utilized to achieve a CD uniformity across a wafer such that each of a plurality of gate stacks formed by common processing have improved uniformity of stack width w across the entire wafer (edge to edge uniformity). In particular instances, no variance in w will be detectable between gate stacks formed near a center of the wafer relative to gate stacks formed proximate the edge of the wafer.

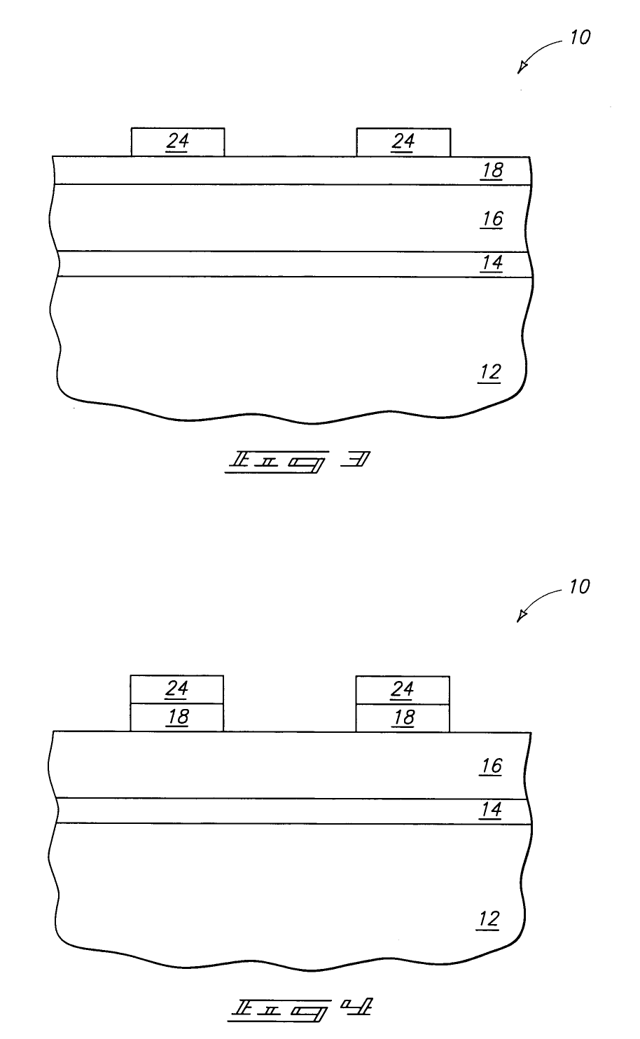

The structure shown in FIG. 1 can be produced in accordance with the invention as described with reference to FIGS. 2-5. Referring initially to FIG. 2, at a preliminary processing step wafer fragment 10 can be provided to have a plurality of layers 14, 16 and 18 formed over substrate 12. Referring to FIG. 3, a patterned mask 24 can be formed over material 18. Preferably patterned mask 24 overlies and defines the region which will become the gate stacks. Mask material 24 can be, for example, a photoresist material and patterning of such material can comprise photolithographic patterning.

In accordance with the invention, the structure shown in FIG. 3 is subjected to plasma etching utilizing a high-density type plasma reactor. Processing in accordance with the invention can comprise, for example, positioning wafer 10 within a reaction chamber, flowing components of a desired etch chemistry into the reactor, generating a plasma from the etch chemistry and utilizing the plasma to etch material 18 as depicted in FIG. 4.

Where material 18 comprises, consists essentially of or consists of silicon nitride, and appropriate etch chemistry can utilize the components CF₄, O₂, and CH₂F₂. These components can be flowed simultaneously (either independently or mixed) into the reaction chamber. In accordance with the invention, at least one of the components will be provided at a flow rate which exceeds flow rate utilized for such component during high-density plasma etching. For example, where conventional high-density plasma etching utilizes a flow rate of 45 sccm CF₄, 20 sccm O₂ and 31 sccm CH₂F₂ to etch silicon nitride (at a chamber pressure of 50 mtorr, a top coil power of 200 watts, a bias power of 400, and with a substrate temperature of about 70° C.), plasma etching in accordance with the invention can use a CF₄ flow rate of from about 100 to about 200 sccm, a O₂ flow rate of from about 40 to about 80 sccm and a CH₂F₂ flow rate of from about 75 to about 125 sccm.

Appropriate top coil power in accordance with the invention can be from about 150 to about 250 watts. Bias power can be, for example, 350 to about 450 watts. Appropriate substrate temperatures can range from about 60° C. through about 80° C. Preferable reactor pressures can be, for example, from about 40 to about 60 mTorr. Typically, processing in accordance with the invention will utilize low-density plasma having a plasma density of less than 1010 ions/cm³, and can have a processing pressure increased relative to conventional high-density plasma processing.

In an exemplary processing event, in accordance with the invention, silicon nitride material 18 was etched utilizing a LAM 2300 reactor (LAM Research Corp.) with a 200 watt top coil power, a 400 watt bias power and a 50 mtorr chamber pressure, and a substrate temperature of 70° C. CF₄ was flowed at 150 scCm, O₂ was flowed at 60 sccm, and CH₂F₂ was flowed at 100 sccm. For the particular construction being processed, these processing conditions were optimal for producing CD uniformity across the wafer. It is to be understood that these values can be adjusted to produce optimal CD uniformity for a particular substrate or construction having, for example, differing materials, structures, densities etc relative to the wafer used above. For example, if the thickness or density of nitride layer 18 varies across the wafer surface, the various flow rates and/or overall mass flow rate can be altered to compensate for the variance. It is to be noted that the invention contemplates altering the flow rate of one or more component of the etch chemistry during the etching process in addition to or alternatively to providing an initial flow process that differs from conventions high-density plasma etch conditions.

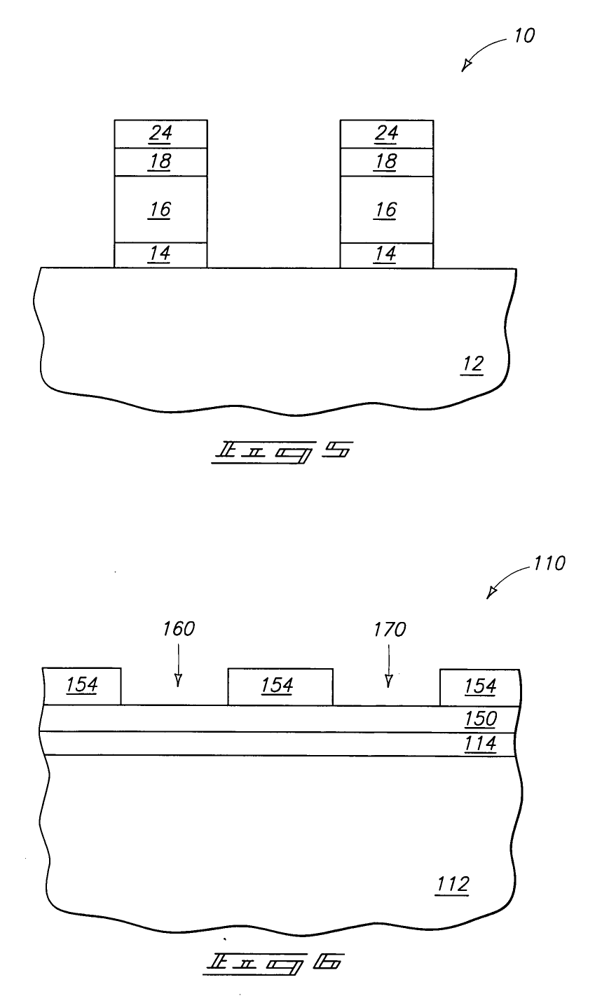

Referring to FIG. 5 after etching material 18, etching can be continued to extend through materials 16 and 14 to produce the stack structures depicted. The etching of materials 16 and 14 can utilize appropriate etch chemistries based upon the particular materials.

Mask material 24 can be removed from over the patterned nitride either prior to of after etching materials 16 and 14 to produce the structure depicted in FIG. 1. Removal of material 24 can be achieved by, for example, resist stripping.

In another aspect, processing in accordance with the invention can be utilized to define and form isolation regions. Exemplary processing to define isolation regions is discussed with reference to FIGS. 6-10. A wafer fragment 100 is depicted comprising a substrate 112 which can be, for example, a semiconductor substrate as discussed above. Wafer fragment 100 can have a pad oxide layer 114 formed over substrate 112 and a sacrificial nitride material 150 such as silicon nitride formed over the pad oxide. A patterned mask 154 can be present over nitride material 150 and can be patterned to have openings 160 and 170 extending through the mask material to nitride layer 150. The patterned mask can be formed by, for example, methodology as described above with respect to patterned mask 24.

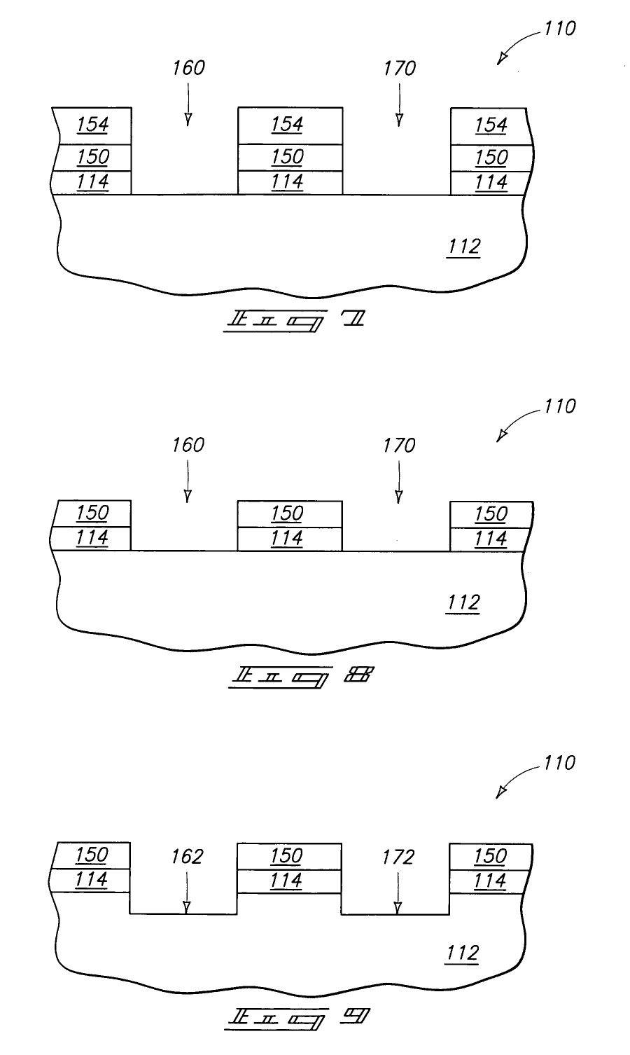

Referring to FIG. 7, substrate 112 can be subjected to plasma etching in accordance with the invention utilizing nitride etch conditions as set forth above. Such conditions can be utilized to extend openings 160 and 170 through nitride material 150. Openings 160 and 170 can be extended through pad oxide layer 114 utilizing the same or an alternative etch chemistry. Processing in accordance with the invention to extend openings 160 and 170 can produce such openings to have substantially equivalent widths. Further, additional openings formed across a wafer surface (not shown) in a common etch processing can each have substantially equivalent widths or CDs, thereby providing center to edge (and edge to edge) CD uniformity.

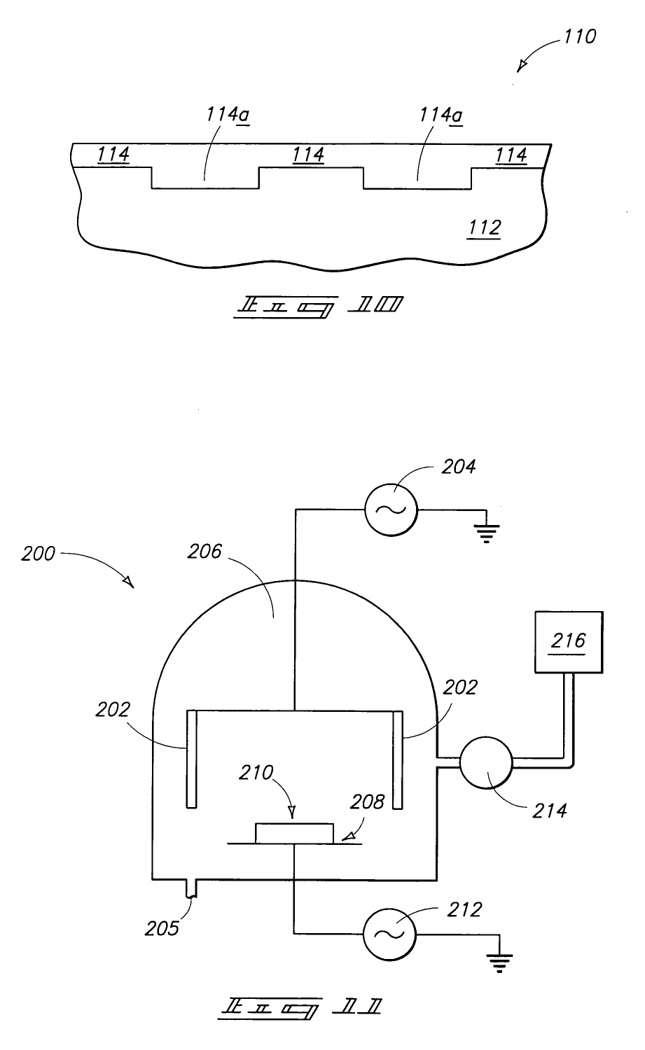

Referring to FIG. 8, patterned mask 154 has been removed from over nitride material 150. With reference to FIG. 9, the openings through the nitride material and pad oxide can be extended to form recess surfaces 162 and 172 within substrate 112. Further processing of substrate 112 can comprise, for example, removal of nitride material 150 and can additionally include oxidation by, for example, thermal oxidation to thermally grow field oxide regions 114a as depicted in FIG. 10. Field oxide regions 114a formed in accordance with methodology of the invention can define isolation regions and can have increased uniformity across the wafer surface relative to conventional processing. Accordingly, the isolation region critical dimension can be substantially equivalent proximate the wafer edge and at or near the center of the wafer.

An exemplary reaction system 200 that can be utilized in a method of the present invention is shown schematically in FIG. 11. System 200 comprises coils 202 connected to a power source 204. Coils 202 surround a reaction chamber 206 and are configured to generate a plasma within chamber 206. A wafer holder (chuck) 208 is provided within chamber 206 and holds a semiconductive wafer 110. Although System 200 is depicted as holding a single semiconductive wafer, it is to be understood that the methodology of the invention can be adapted for chambers configured to hold multiple wafers. Wafer holder 208 is electrically coupled to a power source 212. It is noted that power sources 204 and 212 can be separate power sources or can comprise separate feeds originating from a single power source. For purposes of performing methods of the invention, the power from source 204 can be, for example, from about 150 watts to about 250 watts. The power to wafer 210 from source 212 is preferably biased to a power of about 350 to about 450 watts. In practice, the bias power is typically measured at chuck 208 holding wafer 210 rather than at wafer 210 itself.

A flow of feed gas(es) can be provided into chamber 206 either from a single source 216 or from separate sources (not shown). Where a nitride material is to be etched, such feed gases can include CF₄, O₂ and CH₂F₂. For etching materials other than nitride materials appropriate alternative independent or mixed sources can be provided. The flow of feed gases into chamber 206 can be controlled by, for example, a mask flow controller 214 as depicted, or can be provided through independent flow control devices (not shown). The gas feed and a chamber exhaust 205 can be positioned as depicted, or can be alternatively disposed with respect to the chamber surfaces. Where a nitride is to be etched such as described above, the overall mass flow into chamber 206 can be greater than 200 sccm. The flow rate of independent gases can be as described above.

Although not limited to any particular apparatus, methodology of the invention can be successfully performed utilizing a LAM 2300 reactor. However, with respect to this particular exemplary reactor and alternative high-density inductively coupled reactors, since low-density plasma and high flow rates are being utilized to perform processes of the invention, replacement or alteration of flow rate controllers may be appropriate to achieve the desired flow rate conditions.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of processing a substrate, comprising:
providing a substrate within a high-density plasma reactor, the substrate comprising a material;
generating a low-density plasma within the high-density plasma reactor, the plasma density being less than 10¹⁰ ions/cm³; and
under low-density plasma conditions comprising a reactor pressure of greater than 5 mtorr, plasma-etching the substrate to remove at least some of the material from the substrate.

2. The method of claim 1 wherein the material comprises silicon nitride.

3. The method of claim 1 further comprising flowing an etchant composition into the high-density plasma reaction chamber and maintaining a reaction chamber mass flow rate of greater than about 200 sccm during the flowing, wherein the low-density plasma is generated from the etchant composition within the reaction chamber.

4. The method of claim 3 wherein the etchant composition comprises at least one of O₂, CF₄ and CH₂F₂.

5. The method of claim 3 wherein the flowing the etchant composition comprises flowing O₂ at a flow rate of greater than 40 sccm.

6. The method of claim 3 wherein the flowing the etchant composition comprises flowing CF₄ at a flow rate of greater than 100 sccm.

7. The method of claim 3 wherein the flowing the etchant composition comprises flowing CH₂F₂ at a flow rate of greater than 75 sccm.

8-9. (canceled)

10. The method of claim 1 wherein the substrate is a semiconductor wafer, wherein prior to the plasma etching the material is disposed at a central portion of the wafer and proximate a wafer edge, and wherein the plasma etching etches the material disposed at the central portion of the wafer at the same rate as the material proximate the wafer edge.

11. The method of claim 10 wherein the plasma etching produces a first structural feature having a first feature dimension disposed proximate the central portion of the wafer and a second structural feature disposed proximate the wafer edge having a second feature dimension substantially equivalent to the first feature dimension.

12. The method of claim 1 wherein the substrate is a semiconductor wafer, wherein prior to the plasma etching the material is disposed over at a central portion of the wafer and proximate a wafer edge, and wherein the plasma etching etches the material disposed at the central portion of the wafer faster than the material proximate the wafer edge.

13. The method of claim 12 wherein the plasma etching produces a first structural feature having a first feature dimension disposed proximate the central portion of the wafer and a second structural feature disposed proximate the wafer edge having a second feature dimension substantially equivalent to the first feature dimension.

14. A method of forming a gate stack comprising:
providing a substrate comprising a plurality of layers;
forming a layer of nitride material over the plurality of layers;
positioning the substrate within a high-density plasma reactor;
flowing a composition into the reactor while maintaining a mass flow within the reactor of at least 200 sccm;
generating a low-density plasma utilizing the composition; and
plasma etching the nitride material.

15. The method of claim 14 wherein the plurality of layers comprises a layer of conductive material over a layer of oxide material.

16. The method of claim 14 wherein the plasma-etching forms a patterned nitride block, and further comprising after plasma-etching the nitride material, transferring the pattern to the plurality of layers.

17. The method of claim 14 further comprising providing a patterned mask material over the nitride material prior to the plasma-etching.

18. A method of forming a plurality of features over a semiconductive wafer, comprising:
providing a layer of nitride material over a wafer surface;
providing the wafer within a high-density plasma reactor; and
etching the nitride material within the high-density plasma reactor utilizing low-density plasma conditions.

19. The method of claim 18 wherein the etching the nitride material forms a plurality of openings at least partially through the nitride material, the plurality of openings comprising a first opening proximate an edge of the wafer having a first width, and a second opening proximate the center of the surface having a second width, wherein the first and second widths do not detectibly differ from one another.

20. The method of claim 18 wherein the etching the nitride material etches nitride material disposed proximate the edge of the wafer at a slower rate than at the center of the wafer.

21. The method of claim 18 wherein the etching the nitride material etches nitride material disposed proximate the edge of the wafer and at the center of the wafer of the wafer at substantially equivalent rates.

22. The method of claim 18 wherein the etching the nitride material forms a plurality of patterned nitride blocks comprising a first block proximate an edge of the wafer having a first width, and a second block proximate the center of the surface having a second width, wherein the first and second widths do not detectibly differ from one another.

23. The method of claim 22 further comprising transferring the pattern from the patterned nitride blocks into underlying layers to form a plurality of gate stacks, and wherein gate stack width variance across the wafer is undetectable.
